(19) United States
(12) Patent Application Publication
(10) Pub. No.: US 2023/0387427 A1
(43) Pub. Date: Nov. 30, 2023

(54) EVAPORATIVE COOLING FOR A MOTOR VEHICLE WITH FUEL-CELL DRIVE

(71) Applicant: MAN Truck & Bus SE, Munich (DE)

(72) Inventors: Julius ENGASSER, Munich (DE); Jurgen KOHLER, Niedersickte (DE); Max WAGENBLAST, Dachau (DE); Jan SWOBODA, Munich (DE)

(21) Appl. No.: 18/448,916

(22) Filed: Aug. 12, 2023

Related U.S. Application Data
(63) Continuation of application No. PCT/EP2022/051024, filed on Jan. 18, 2022.

(30) Foreign Application Priority Data
Feb. 15, 2021 (DE) 10 2021 103 449.3

(51) Int. Cl. H01M 8/04007; H01M 8/04029; H01M 8/04119; H01M 8/04746

(52) U.S. Cl. CPC H01M 8/04059; H01M 8/04029; H01M 2250/20; H01M 8/04768; H01M 8/04776; H01M 8/04164

(57) ABSTRACT

A fuel cell system for a vehicle, comprising a fuel cell and a water collection device for collecting liquid water from exhaust gas of the fuel cell, comprising an exhaust gas cooler including a heat exchanger which cools the exhaust gas by transferring heat from the exhaust gas to a flow of a cooling medium and condenses water contained in the exhaust gas and comprising a water tank for storing the collected water, a cooling device for cooling the fuel cell comprising a cooler, and a water ejection device for ejecting and distributing water. The water tank may be pressurized. A control means may choose operating modes for the fuel cell system that comprise an operating mode for water collection and an operating mode for water ejection based on a power schedule that comprises a sequence of scheduled operating phases with varying power requirements for the fuel cell system.

### CROSS-REFERENCE TO RELATED APPLICATIONS

This is a bypass-continuation application of International PCT Application No. PCT/EP2022/051024, filed on Jan. 18, 2022, which claims priority to German Patent Application No. 20 2021 103 449.3, filed on Feb. 15, 2021, which are incorporated by reference herein in their entirety.

### TECHNICAL BACKGROUND

The invention relates to a fuel cell system for a vehicle, having a cooling device comprising a cooler, a water collection device for collecting liquid water from exhaust gas of the fuel cell, and having a water ejection device for ejecting and distributing collected liquid water on the cooler or in a supply air stream of the cooler.

US 2020/0044264 A1 describes a fuel cell system having a cooling device adapted to cool the fuel cell by heat exchange using a heat transfer medium, a water reservoir storing water, an air exhaust duct for exhausting an air exhaust gas from the fuel cell having a back pressure adjusting valve for adjusting the pressure of the pressurized exhaust gas and a high pressure introduction passage connecting the water reservoir to the air discharge passage upstream of the back pressure adjusting valve in an air flow direction, and a spraying device for spraying the water of the water reservoir over the cooling device. The spraying device is adapted to spray the water of the water reservoir pumped by the pressure of the air exhaust over the cooling device.

KR 20170059515 A describes a fuel cell cooling system having a cooler for exhausting heat from a fuel cell stack coolant and a spray nozzle that mixes compressed air and water and sprays the mixture on a surface or front of the cooler.

US 2007/0134526 A1 describes a fuel cell system with a water recovery device for separating and recovering water from exhaust gas of the fuel cells.

JP 2007-242280 A describes a fuel cell system having a coolant supply device for circulating a coolant inside the fuel cell and a cooler for cooling the coolant. Downstream of the cooler, a cathode gas inlet is arranged to receive cathode gas supplied to the fuel cell and spray means to spray exhaust gas water toward the cooler.

EP 1 384 967 A2 describes a fuel cell cooling system with a cooling system. A fan blows air through a heat exchanger of the cooling system. The cooling system comprises an evaporative unit exposed to the air flow and a conduit supplying exhaust water from the fuel cell stack to the evaporative unit. The exhaust water evaporates, thereby cooling the air and reducing the amount of liquid exhaust water.

### SUMMARY OF THE INVENTION

When operating fuel cell-powered vehicles, it is a major challenge to cool the fuel cell system at high ambient temperatures.

A fuel cell is usually an electrochemical energy converter in which two reactants hydrogen and oxygen react to release thermal and electrical energy to form water. Hydrogen, which serves as energy storage or fuel, is carried in a tank in liquid or gaseous form in the vehicle, while oxygen from the ambient air can be used. Despite the high efficiency of a fuel cell, the operation of a fuel cell stack generates reaction waste heat, only a small part of which is exhausted via the fuel cells' exhaust gas. The greater part of the waste heat must be exhausted to the environment via a cooling system with at least one cooler. The fuel cell has a relatively low operating temperature. For example, a maximum permissible coolant temperature of the cooling system can be in the range of about 80° C. to 95° C., preferably in the range of about 80° C. to 90° C. Since the cooling capacity of a cooler (the ability to transfer heat from the coolant to the environment) depends largely on the temperature difference between the coolant of the cooler and the environment, the low temperature level of the operating temperature of the fuel cell, and thus of the coolant, makes it difficult to transfer heat to the environment. The low temperature level of the fuel cell and the low heat dissipation through the fuel cell exhaust gas are two effects that make the development of a much more effective cooling system for fuel cell vehicles desirable. In a cooling device in which water is sprayed onto a surface of a cooler of the cooling device, the cooling performance is increased by utilizing the evaporation energy of the phase change of water from liquid to gas.

It is the task of the invention to specify a system that enables particularly efficient evaporative cooling for a fuel cell of a motor vehicle with fuel cell drive.

According to the invention, the task is solved by a fuel cell system for a vehicle, including: a fuel cell; an exhaust line for exhausting exhaust gas containing water from the fuel cell; a water collection device for collecting liquid water from the exhaust gas, the water collection device including an exhaust gas cooler, wherein the exhaust gas cooler comprises a heat exchanger disposed on the exhaust line and adapted to, by transferring heat from the exhaust gas to a flow of a cooling medium, cool the exhaust gas passed in the exhaust line via the heat exchanger and condensing water contained in the exhaust gas, wherein the water supplied to the heat exchanger with the exhaust gas, including the water condensed therefrom, is discharged from the heat exchanger via the exhaust line; said fuel cell system further including: a water tank coupled to the water collection device downstream of the heat exchanger and adapted to store collected water; a cooling device for cooling the fuel cell, comprising a cooler; a water ejection device for ejecting and distributing water on the cooler or in a supply air stream of the cooler; and a water line for supplying water from the water tank to the water ejection device.

The heat exchanger may be adapted to condense water vapor contained in the exhaust gas and/or gaseous water contained in the exhaust gas. The condensed water and any uncondensed portion of the water are exhausted from the heat exchanger via the exhaust line.

The fuel cell may be in the form of a fuel cell stack. The fuel cell is preferably designed for an electrochemical reaction of oxygen contained in air and hydrogen. The exhaust gas containing water can be cathode-side exhaust gas and/or anode-side exhaust gas of the fuel cell. Depending on the operating point of a fuel cell, a large proportion of the water in the exhaust gas stream of the fuel cell is present in vapor or gaseous form, and only a small proportion of the water is liquid. As the exhaust gas flows through the heat exchanger, water condenses and is carried out of the heat exchanger with the exhaust gas flow. The heat exchanger can increase a percentage of liquid water in the exhaust gas passing over the heat exchanger in the exhaust line. The heat exchanger may add additional liquid water condensed from the exhaust gas to any liquid water already contained upstream in the exhaust gas.

The water tank may be coupled to the exhaust line. The water tank may be arranged to store recovered water discharged through the exhaust line. The water tank may be adapted to store recovered water discharged from the heat exchanger via the exhaust line. The water tank may be coupled to the exhaust line downstream of the water collection device. In particular, the water tank is adapted to store liquid water. The water tank may serve to store liquid water obtained by the water collection device.

As a result, a relatively large amount of liquid water can be collected from the exhaust gas and stored in the water tank for later use in cooling the cooler and/or the inlet cooling air stream. Thus, additional recovered water can be supplied to the water tank when water is recovered from the fuel cell exhaust gas by the water collection device in a fuel cell system operating mode, and water from the water tank can be used to cool the cooler to increase the cooling capacity of the cooling device to cool the fuel cell and/or reduce the power required to operate the cooling device in a high power fuel cell operating mode. In this way, for example, a water supply can be built up that can be used for cooling during operation of the fuel cell with a particularly high cooling demand without having to recover further water at the same time. In this way, particularly efficient operation of the fuel cell system can be made possible during power peaks. Also, by storing water in the water tank, longer operation of the fuel cell system at high power can be made possible even at high ambient temperatures. Advantageously, the water tank also allows more water to be ejected during an ejection of water to cool the cooler and/or the supply air stream of the cooler than is collected at the same time by the water collection device.

Particularly advantageously, to collect larger amounts of water from the exhaust gas and store the collected water in the water tank, the heat exchanger transfers heat from the exhaust gas to a flow of a cooling medium. Depending on the design of the fuel cell system, a cooling or refrigeration circuit with a cooling medium can be provided to carry out this heat transfer, or ambient air can be used as the cooling medium. Thus, for example, free capacity of a cooling or refrigeration circuit of the vehicle can be used to collect water by the water collection device, or ambient air can be used. A flow of ambient air across the heat exchanger may be effected, for example, by the motion of the moving vehicle relative to the environment, and/or a fan may be provided to create a forced air flow. Thus, in an energy-efficient manner, the amount of water stored in the water tank and the amount of liquid water in the exhaust gas flow can be actively increased, with cooling capacities of a flow of the cooling medium readily available depending on the operating situation of the vehicle. This enables high energy and cooling efficiency of the overall system.

Exploitation is made of the fact that by ejecting and distributing water onto the cooler or into a supply air stream of the cooler, effective evaporative cooling of the cooler is achieved, whereby energy-efficient operation of the cooling device for cooling the fuel cell can be achieved. The water tank thereby makes it possible to cushion longer operating phases with a high power requirement of the fuel cell and thus a high cooling power requirement of the cooling device.

It is thus possible to collect water to be used later for cooling from the exhaust air of the fuel cell, store it in the water tank, and, for example, spray the water onto the cooler of the cooling device for cooling the fuel cell or into a supply air stream of the cooler when the fuel cell has a high cooling demand. Non-adiabatic cooling of the cooler can be achieved, and/or adiabatic evaporative cooling can be achieved by spraying the water into the supply air stream of the cooler.

The exhaust line may also be referred to as the exhaust and product water line, through which an exhaust gas stream from the fuel cell is passed over the heat exchanger of the exhaust gas cooler. The exhaust gas cooler may also be referred to as an exhaust gas cooling device. The fuel cell system may comprise an evaporative cooling system, which may comprise the water tank and the water ejection device.

The heat exchanger is preferably arranged to cool the exhaust gas passed in the exhaust line over the heat exchanger by indirect transfer of heat from the exhaust gas to the flow of the cooling medium, and to condense water contained in the exhaust gas. Thus, there is no mass transfer between the exhaust gas and the flow of the cooling medium. The heat exchanger is preferably a heat exchanger without mass transfer. For example, the flow of the cooling medium may be separated from the flow of the exhaust gas via the heat exchanger.

The heat exchanger may be arranged to exhaust the water supplied to the heat exchanger with the exhaust gas, including the water condensed therefrom, from the heat exchanger via the exhaust line. The heat exchanger thus exhausts the supplied exhaust gas stream while increasing the proportion of liquid water in the exhaust gas stream. The exhaust gas stream supplied to the heat exchanger together with the water contained therein is exhausted from the heat exchanger via the exhaust line. The exhaust line can, for example, be closed to the heat exchanger and/or to the flow of the cooling medium. Thus, water contained in the exhaust gas is carried over the heat exchanger in the exhaust line that is closed with respect to the heat exchanger and/or the cooling medium. This makes it possible for the water contained in the exhaust gas to be guided in the exhaust line above the heat exchanger without loss (without water being discharged to the cooling medium).

Preferably, the flow of the cooling medium is separate from the exhaust gas carried in the exhaust line. Preferably, the flow of the cooling medium is separated from the exhaust gas by a heat-permeable/heat-transferring wall. For example, the wall may be a wall of the heat exchanger and/or a wall of the exhaust line.

The water ejection device may, for example, be or comprise a water spraying device for spraying water onto the cooler or into a supply air stream of the cooler. Spraying the water results in a particularly fine distribution, such that evaporation is favored.

In embodiments, the cooling device for cooling the fuel cell may comprise a cooling circuit comprising a cooling medium, the cooling circuit comprising a cooling path that passes over the heat exchanger. The cooling circuit or coolant circuit may comprise a pump. The cooling circuit may comprise the cooler. The cooling circuit may also be referred to as the primary cooling circuit of the fuel cell. The cooling circuit may be arranged to provide the flow of the cooling medium through the heat exchanger. Thus, this cooling medium of the cooling circuit may provide the flow of the cooling medium via the heat exchanger. In the heat exchanger, heat can thus be transferred from the exhaust gas to the cooling medium of the cooling circuit of the cooling device for cooling the fuel cell. The cooling path may be, for example, a side path or branch of the cooling circuit that passes over the heat exchanger. The cooling circuit may comprise, for example, a valve for controlling a flow of the cooling medium through the cooling path. It is particularly advantageous that in an operating phase of medium power of the fuel cell, in which a relatively high proportion of water is contained in the exhaust gas of the fuel cell, a free cooling capacity of the cooling circuit of the cooling device can be used to exhaust heat from the exhaust gas of the fuel cell in the heat exchanger. Thus, especially in an operating phase in which the full electrical power of the fuel cell is not demanded and in which, accordingly, the cooling circuit of the cooling device has free cooling capacity, water can be collected from the exhaust gas and stored in the water tank for later use to increase performance. Overall, this enables particularly efficient operation of the fuel cell system. Increased cooling by the primary cooling circuit of the fuel cell can increase the proportion of liquid water in the exhaust gas stream. Thus, the amount of water stored in the water tank as well as the proportion of liquid water in the exhaust gas flow can be actively increased in an energy-efficient manner, whereby free cooling capacities of a flow of the cooling medium can be used depending on the operating situation of the vehicle. This enables high cooling and energy efficiency of the overall system.

The cooling device for cooling the fuel cell may be a conventional or simple coolant circuit or a high-temperature compression refrigeration circuit, for example with several cooling stages connected in series, each of which may comprise a coolant circuit with compressor and expansion valve, two cooling stages connected in series being coupled to one another via a heat exchanger. In particular, the cooling device may comprise the or a cooling circuit in the form of a high temperature compression refrigeration circuit.

In embodiments, the flow of cooling medium through the heat exchanger may be or comprise a flow of air from the environment of the vehicle. Thus, heat from the fuel cell exhaust gas can be exhausted to air from the environment of the vehicle. Thus, exhaust gas cooling can be performed in a particularly efficient manner. In particular, exhaust gas cooling can also be performed in an energy-efficient manner during an operating phase with a high power requirement on the fuel cell.

The fuel cell system may further include a pump connectable to the water tank and arranged to deliver water in the direction from the water collection device or exhaust line to the water ejection device. The pump may be located upstream or downstream of the water tank. The pump may be arranged to deliver water collected by the water collection device or water exhausted from the heat exchanger via the exhaust line to the water tank, or to exhaust water from the water tank to the water ejection device. There may also be a pump arranged upstream of the water tank as well as another pump arranged downstream of the water tank. The provision of a pump has the advantage that an influence of the operation of the water ejection device on the exhaust gas pressure and thus on the operating point of the fuel cell can be avoided.

In embodiments, the water tank may be pressurizable by a pressure source, wherein the water line includes a valve via which the water tank is connectable to the water ejection device, wherein the water ejection device is arranged to eject water from the water tank connected by the valve by the pressure applied to the water tank and to distribute it on the cooler or in a supply air stream of the cooler.

According to a second aspect, the problem is solved by a fuel cell system for a vehicle, including: a fuel cell adapted for electrochemical reaction of oxygen contained in air and hydrogen; an exhaust line for exhausting exhaust gas containing water from the fuel cell; a water collection device for collecting liquid water from the exhaust gas; a water tank coupled to the water collection device and adapted to store collected water; and a cooling device for cooling the fuel cell, comprising a cooler; a water ejection device for ejecting and distributing water on the cooler or in a supply air stream of the cooler; and a water line for supplying water from the water tank to the water ejection device, wherein the water tank is pressurizable by a pressure source, wherein the water conduit includes a valve through which the water tank is connectable to the water ejection device, wherein the water ejection device is adapted to eject water from the water tank connected by the valve by the pressure applied to the water tank and to distribute it on the cooler or in a supply air stream of the cooler.

The water tank may be coupled to the exhaust line. The water tank may be configured to store collected water discharged through the exhaust line. The water tank may be coupled to the exhaust line downstream of the water collection device. In particular, the water tank is adapted to store liquid water. The water tank may be adapted to store liquid water obtained by the water collection device.

The water ejection device is thus adapted to receive water from the water tank connected by the valve by the pressure applied to the water tank, eject it, and distribute it on the cooler or in a supply air stream of the cooler. By being able to pressurize the water tank by a pressure source, the advantage is achieved that without a pump or independently of the operation of a pump, the water stored in the water tank can be supplied and ejected from the water tank to the water ejection device and distributed on the cooler or in the supply air stream of the cooler by the pressure applied to the water tank.

Thus, in an operating phase in which a particularly high power of the fuel cell is called up and the fuel cell can be cooled particularly efficiently by the distributed water, no additional pump needs to be operated to convey and eject the water from the water tank to the water ejection device. Particularly during power peaks, this enables the fuel cell system to operate especially efficiently. For example, a pressurized water tank may allow water to be efficiently stored and made available as needed for cooling the cooler of the cooling device for cooling the fuel cell.

In particular, the pressure source may be a source of compressed air. For example, air communicating with the water tank, such as air communicating with a free surface of the water stored in the water tank, may be pressurized by the pressure source.

In particular, the water tank may be pressurizable with compressed air. This may also make it possible to blow the water line and/or the water exhaust device free with air and/or to empty the water tank at the end of a journey of the vehicle and/or when the fuel cell system is switched off. This is particularly advantageous with regard to a possible prevention of frost damage due to freezing residual water, as well as with regard to a cleaning of the water line and/or the water ejection device.

The fuel cell system may further include a pump arranged to feed water discharged from the heat exchanger via the exhaust line into the water tank against the pressure applied to the water tank. A valve can be arranged between the pump and the water tank, for example, in particular a check valve.

In that the water tank can be pressurized by a pressure source and the pump can feed recovered water into the water tank against this pressure, not only is the advantage achieved that, irrespective of the operation of the pump, the water stored in the water tank can be fed from the water tank to the water ejection device by the pressure to which the water tank is pressurized and distributed on the cooler or in the supply air stream of the cooler. At the same time, the advantageous effect of allowing the water tank to store a supply of water is also achieved. This is because additional liquid water collected from the exhaust gas can be supplied by the pump to water already present in the water tank against the pressure prevailing in the water tank when water is recovered from the exhaust gas of the fuel cell in an operating mode of the fuel cell system, and water from the water tank can be used to cool the cooler to increase the cooling capacity of the cooling device and/or reduce the power required to operate the cooling device in a high power operating mode of the fuel cell. In particular, it is enabled that the water recovery and feeding of recovered water into the water tank by the pump can be performed independently of the water collection from the water tank and use of the collected water by the water ejection device. In this way, for example, a water supply can be built up that can be used for cooling during operation of the fuel cell with a particularly high cooling requirement, without the need to simultaneously recover further water or operate the pump to supply further water to the water tank. This enables particularly efficient operation of the fuel cell system during power peaks. Also, prolonged operation of the fuel cell system at high power can be enabled even at high ambient temperatures.

In embodiments of the above aspects, the fuel cell system may further include a control means arranged for an operation mode of the fuel cell system in which: operating modes for the fuel cell system comprising at least one operating mode for water collection and at least one operating mode for water ejection are selectively selected by the control means according to the planned operating phases, on the basis of a power schedule comprising a sequence of planned operating phases with different power requirements for the fuel cell system, wherein in the at least one operating mode for water collection, the water collection device is operated to collect liquid water from the exhaust gas and supply it to the water tank, and wherein in the at least one operating mode for water ejection, water is supplied from the water tank to the water ejection device and ejected from the water ejection device and distributed on the cooler or in a supply air stream of the cooler.

According to a third aspect, the problem is solved by a fuel cell system for a vehicle, comprising: a fuel cell adapted for electrochemical reaction of oxygen contained in air and hydrogen; an exhaust line for exhausting exhaust gas containing water from the fuel cell; a water collection device for collecting liquid water from the exhaust gas; a water tank coupled to the water collection device and adapted to store collected water; and a cooling device for cooling the fuel cell, comprising a cooler; a water ejection device for ejecting and distributing water on the cooler or in a supply air stream of the cooler; and a water pipe for supplying water from the water tank to the water ejection device; and a control means adapted for an operating method of the fuel cell system in which: operating modes for the fuel cell system comprising at least one operating mode for water collection and at least one operating mode for water ejection are selectively selected by the control means based on a power schedule comprising a sequence of scheduled operating phases with different power requirements for the fuel cell, in accordance with the scheduled operating phases, wherein in said at least one operating mode for water collection, said water collection device is operated to collect liquid water from said exhaust gas and supply it to said water tank, and wherein, in the at least one operating mode for water ejection, water is supplied from the water tank to the water ejection device and is ejected from the water ejection device and distributed on the cooler or in a supply air stream of the cooler.

The control means may be arranged to control and/or perform the operating method. The control means may be arranged to control an operation of the water collection device and the water ejection device in accordance with the operating method.

For example, in the at least one operating mode for water collection, the water ejection device may be operated by the control means. In the at least one operating phase for water ejection, for example, water may be supplied from the water tank to the water ejection device and ejected from the water ejection device and distributed to the cooler or into a supply air stream of the cooler under control of the control means.

The power schedule may comprise an anticipated sequence of scheduled operating phases with varying power requirements for the fuel cell. The operating method may also be referred to as a predictive operating method or a predictive operating method.

By the described operating method, a capacity of the water tank can be particularly well utilized to switch between an operating mode for water collection and an operating mode for water ejection in a manner that is pre-planned by the power schedule. For example, in accordance with a planned operating phase with a relatively high power requirement for the fuel cell, an operating mode for water ejection can be selected to cause an increase in the cooling capacity of the cooling device for the fuel cell by evaporative cooling of the water. In this way, for example, an anticipated required amount of water can be collected and provided in the water tank for a planned duration of maintaining the operating mode. Overall, more selective use of the water tank can enable more energy-efficient operation of the vehicle. In addition, the amount of water to be collected can be limited to a sufficient amount based on the power schedule. Unnecessary collection of excess water that is not needed can be avoided.

For example, the control means may be arranged to control, according to the selected operating mode, the exhaust gas cooler, to control a valve controlling a flow of the cooling medium through the cooling path (via the heat exchanger), to control the operation of the exhaust gas cooler by controlling this valve, to control the water ejection device, to control the valve(s) of the water line through which the water tank is connectable to the water ejection device, and/or to control a/the pump arranged to feed water discharged from the heat exchanger via the exhaust line into the water tank, and/or to control a/the pump connectable to the water tank and arranged to convey water in the direction from the water collection device or exhaust line to the water ejection device, and/or to control a/the pump arranged to exhaust water from the water tank to the water ejection device.

The respective scheduled operating phases may have respective operating modes associated with them or may be associated with them by the control means. For example, the control means may select an operating mode corresponding to a power requirement for the fuel cell of the respective operating phase.

For example, the control means may be arranged to selectively choose operating modes for the fuel cell system according to the scheduled operating phases, wherein when the vehicle reaches one of the scheduled operating phases, a corresponding operating mode for the fuel cell system is selected.

For example, the power schedule may determine a power requirement for the fuel cell based on a location history of the vehicle and/or a time history. For example, the location history or the time history may be specified with respect to a location of the vehicle at a particular time. The power schedule may comprise, for example, a route schedule for the power and/or a schedule for the power. For example, the power schedule may comprise route sections and/or time sections with varying power requirements for the fuel cell.

Thus, for example, a corresponding operating mode for water ejection can be assigned to a route section or a time section on which a hill climb is provided and selected by the control means. Thus, on a hill climb, the water ejection device can be operated in a pre-planned manner from the collected water provided in the water tank to cool the cooler of the fuel cell cooling device. For example, the operating phases of the schedule may be ordered by times and/or locations. For example, the power schedule may show (represent) power requirements or operating phases based on location and/or time.

The at least one operating mode for water ejection may comprise an operating mode for water ejection in which the water collection device or the exhaust gas cooler or a pump for supplying collected water to the water tank is not operated or is not actively operated. In this way, when the power requirement for the fuel cell is particularly high, energy consumption for operating the water collection device can be avoided or reduced. Active operation is understood to mean controlled operation.

The control means may be arranged to adjust the power schedule during a journey of the vehicle based on a current movement of the vehicle, in particular based on a current progress of movement of the vehicle. For example, the power schedule may be adapted based on a current speed of the vehicle or based on a time period of a standstill of the vehicle. Thus, continuous updating of the power schedule during a movement of the vehicle is enabled.

The features according to the above description of the third aspect may be combined with the features according to the other aspects.

In the above second or third aspect, the water collection device may optionally comprise a or the exhaust cooler comprising a or the heat exchanger disposed on the exhaust line and adapted to, by transferring heat from the exhaust gas to a flow of a cooling medium, cool the exhaust gas passed in the exhaust line via the heat exchanger and condense water contained in the exhaust gas, wherein the water supplied to the heat exchanger with the exhaust gas, including water condensed therefrom, is exhausted from the heat exchanger via the exhaust line. For example, the water tank may be coupled to the water collection device and/or to the exhaust line via the pump downstream of the heat exchanger. The exhaust gas cooler may correspond to the exhaust gas cooler described above.

The fuel cell system according to any of the aspects explained above may be advantageously combined with the features described below.

The cooler of the cooling device for cooling the fuel cell may include a fan drive. For example, the cooler may include a fan driven by the fan drive. The fan may be configured to generate an airflow over/through the cooler. The air stream upstream of the cooler may be referred to as the supply air stream of the cooler. The fuel cell system may comprise a/the control means arranged for an operating mode for water ejection, wherein the water ejection device ejects and distributes water onto the cooler or in a supply air stream of the cooler, and wherein the control means controls a power of the fan drive of the cooler. For example, the control means may control the power of the fan drive of the cooler based on whether water ejection occurs. For example, the control means may control a power of the fan drive of the cooler in consideration of a cooling effect of the distributed water. For example, the control means can control a power of the fan drive of the cooler depending on a power requirement of the fuel cell and/or taking into account a cooling effect of the distributed water. Thus, it is possible to reduce a power of the fan drive of the cooler compared to an operation of the fan drive without water ejection and/or to increase the cooling power of the cooler. Since a high proportion of the waste heat in a fuel cell must be exhausted by a cooling device of the fuel cell, it is thus possible to significantly reduce the electrical power requirement of the fan drive by controlling the fan drive while taking water ejection into account, thereby significantly improving the efficiency of the fuel cell system.

The fuel cell system may further include a gas-liquid separator which is connected to the exhaust line and from which water separated from the exhaust gas may be supplied to the water tank. For example, the gas-liquid separator may be located upstream of the water tank. The gas-liquid separator may be arranged downstream of the exhaust gas cooler and/or downstream of the heat exchanger of the exhaust gas cooler. The gas-liquid separator may be integrated in the exhaust line and/or in the heat exchanger. Gas separated from the exhaust gas in the gas-liquid separator can be discharged to the environment, for example. The gas-liquid separator may be connected to a water storage tank or water buffer tank to temporarily store water separated from the exhaust gas. The water storage tank may be located upstream of the water tank. The gas-liquid separator may, for example, be connected to the water tank via a/pump, the pump being arranged to supply water separated from the exhaust gas in the gas-liquid separator to the water tank. The optional water tank can, for example, be arranged between the gas-liquid separator and the pump.

A valve can be arranged between a pump(s) arranged upstream of the water tank and the water tank, for example, in particular a check valve.

A branch valve may be arranged on the exhaust line to branch off excess gaseous exhaust gas from the exhaust line. The branched exhaust gas can be discharged to the environment, for example.

The water line for supplying water from the water tank to the water ejection device may, for example, include a valve via which the water tank can be connected to the water ejection device. The control means may, for example, be arranged to control this valve to control ejection and distribution of water onto the cooler or into a supply air stream of the cooler. If a pump is provided to supply water from the water tank to the water ejection device, the control means may be arranged to control this pump to control ejection and distribution of the water onto the cooler or into a supply air stream of the cooler.

For example, if the water tank is pressurizable by a pressure wave, the pressure source may be a compressed air source. For example, the fuel cell system may comprise a valve through which the pressurized air source is connectable to the water tank. The control means may be arranged to control this valve, for example.

For example, the water tank may be connectable to a drain valve to allow the water tank to be emptied when required. The control means may, for example, be arranged to control the drain valve, possibly as a function of the ambient temperature. This may, for example, prevent the water stored in the water tank from freezing at the end of a journey of the vehicle.

The water tank can be connected to a pressure drain valve, for example. The pressure release valve may be arranged to release a pressure of air communicating with the water in the water tank. For example, the control means may be arranged to open the pressure release valve when the vehicle stops moving, for example when the vehicle drive is switched off, to release the pressure at the pressure tank. This can make it possible, for example, to fill the water tank with water supplied from outside via a cap or to replenish its filling. During journeys with long operating phases of high power requirement on the fuel cell, water supplied from outside, for example by a driver during a break in driving, can thus be used for the water ejection device to cool the cooler of the cooling device for the fuel cell.

In particular, an air compressor can be used as the pressure source or compressed air source.

A compressed air system present in the vehicle can be used as a pressure source, for example a pneumatic compressed air system provided for operating a brake system of the vehicle and/or for shifting a transmission of the vehicle, for example. Thus, a pressure source can be readily provided for pressurizing the water tank, particularly in large utility vehicles.

The described operating method may be used with the fuel cell device according to the embodiments described. In addition or further, control of the operation of the water collection device and/or the water ejection device may be performed in response to a current power requirement of the fuel cell and/or a current cooling power requirement of the cooling device. For example, if the requested fuel cell power of the fuel cell falls below a threshold value of, for example, 70% of the maximum fuel cell power, the control means may be arranged to switch on an operating mode for water collection in which the water collection device is actively operated. When an upper threshold value of, for example, 80% of the maximum fuel cell power is exceeded, it is possible, for example, to switch to an operating mode for water ejection by the water ejection device.

### BRIEF DESCRIPTION OF THE DRAWINGS

The invention is described in detail below with reference to figures. In the figures shows:

FIG. 1 a schematic representation of a fuel cell system according to embodiments of the present disclosure;

FIG. 2 a schematic representation of a schematic example of an exhaust gas cooler according to embodiments of the invention;

FIG. 3 a schematic representation of another example of an exhaust gas cooler according to embodiments of the invention;

FIG. 4 a schematic representation of a water spray device according to embodiments of the invention;

FIG. 5 an operating method of the fuel cell system according to embodiments of the invention; and

FIG. 6 a graph schematically indicating a condensation rate as a function of an exhaust gas temperature.

### DETAILED DESCRIPTION

In the following, unless otherwise noted, the same reference signs are used for the same elements and elements having the same effect.

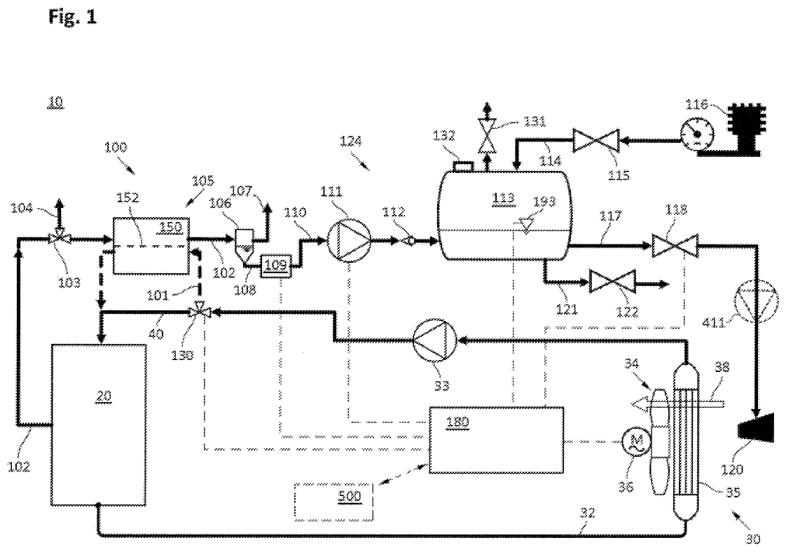

FIG. 1 shows a schematic diagram of a fuel cell system 10 for a vehicle according to embodiments of the present disclosure. The fuel cell system 10 comprises a fuel cell 20 and a cooling device 30 for the fuel cell 20. The cooling device 30 comprises a cooling circuit 32 with a pump 33, a cooler 35 and a fan 34 arranged on the cooler 35. The pump 33 is arranged to pump a cooling medium contained in the cooling circuit 32 through the fuel cell 20 and the cooler 35.

The fan 34 comprises a fan drive 36, and the fan 34 is configured to generate a cooling air stream 38 over or through the cooler 35 to cool the cooling medium by heat exchange with the cooling medium to dissipate waste heat from the fuel cell 20 to the ambient air in the cooling air stream 38 via the cooling circuit 32.

The fuel cell system 10 comprises a water collection device 100 having an exhaust line 102 for exhausting exhaust gas containing water from the fuel cell 20, an exhaust gas cooler 105, a gas-liquid separator 106, a water reservoir 109, and a high pressure pump 111, which are coupled together in this order. Via a switchable branch valve 103, the exhaust gas flow from the fuel cell 20 can be supplied to the exhaust gas cooler 105 through the exhaust line 102. Depending on the switch position of the branch valve 103, a portion of the exhaust gas flow may be vented to the environment through an exhaust line 104.

The exhaust gas cooler 105 comprises a heat exchanger 150 arranged on the exhaust line 102. The exhaust line 102 is routed through the heat exchanger 150. Further, a secondary path 101 of the cooling circuit 32 is passed through the heat exchanger 150. The cooling medium of the cooling circuit 32 and the exhaust gas of the fuel cell 20 conducted through the exhaust line 102 are in heat exchange with each other via a heat permeable wall 152 of the heat exchanger 150. The cooling circuit 32 comprises a controllable, for example continuously variable, valve 130 at which the secondary path 101 branches off from the main path or primary path 40 of the cooling circuit 32. The operation of the heat exchanger 150, and thus the exhaust gas cooler 105, is thus controllable by the controllable valve 130.

The gas-liquid separator 106 is connected to the water reservoir 109 via a pipeline 108. Any remaining water vapor can be discharged to the environment via an outlet line 107.

The high-pressure pump 111 is connected to the water reservoir 109 via a pipeline 110. It is part of an evaporative cooling system 124 for cooling the cooler 35 of the cooling circuit 32. The evaporative cooling system 124 further comprises a pressurizable water tank 113 and a water ejection device 120 connectable thereto. The water tank 113 is pressurizable by means of compressed air via a pipeline 114 and a valve 115 arranged on the pipeline 114 by means of a pressure source 116 in the form of an air compressor or air presser. The high-pressure pump 111 is connected to the water tank 113 via a check valve 112, and is adapted to supply water from the water reservoir 109 to the water tank 113 through the check valve 112 while overcoming the pressure applied to the water tank 113.

An outlet of the water tank 113 is connected to the water ejection device 120 via a water line 117 and a switchable valve 118, which is arranged on the water line 117. Further, the water tank 113 is connected at a drain port 121 to a drain valve 122 for draining water contained in the water tank 113 when required. A pressure release valve 131 for releasing compressed air and a closure 132 for manually filling the water tank 113 are further arranged at the water tank 113.

A control means 180 for controlling the fuel cell system 10 is particularly connected to the controllable valves 103, 130, 115, 118, 122, 130 for controlling the same and is adapted to control the high pressure pump 111 and the fan drive 36. The control means 180 may be further connected to sensors 193 for detecting a level in the water reservoir 109 and/or in the water tank 113.

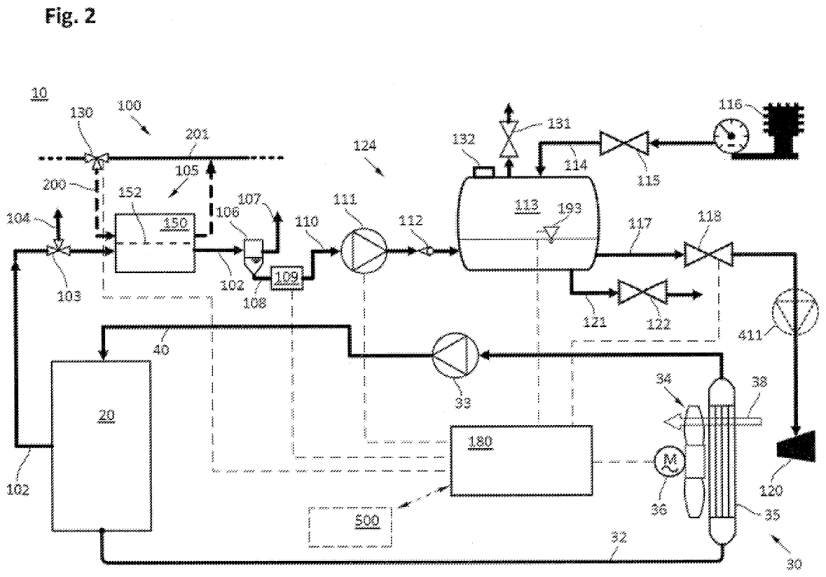

FIG. 2 schematically shows an embodiment example in which the exhaust gas cooler 105 comprises a heat exchanger 150 connected to a secondary path 200 of a second cooling or refrigeration circuit 201 of the vehicle (for example, an air conditioning system, a battery cooling system, or a cooling system of an auxiliary unit such as a DC-DC converter, vehicle electrical system intermediate converter, electrical machines, inverters) instead of the secondary path 101. The secondary path 200 can in turn be connected to the second cooling or refrigeration circuit 201 by a controllable valve 130, in particular one that can be switched continuously. Incidentally, the fuel cell system can be constructed in the same way as the fuel cell system 10 of FIG. 1.

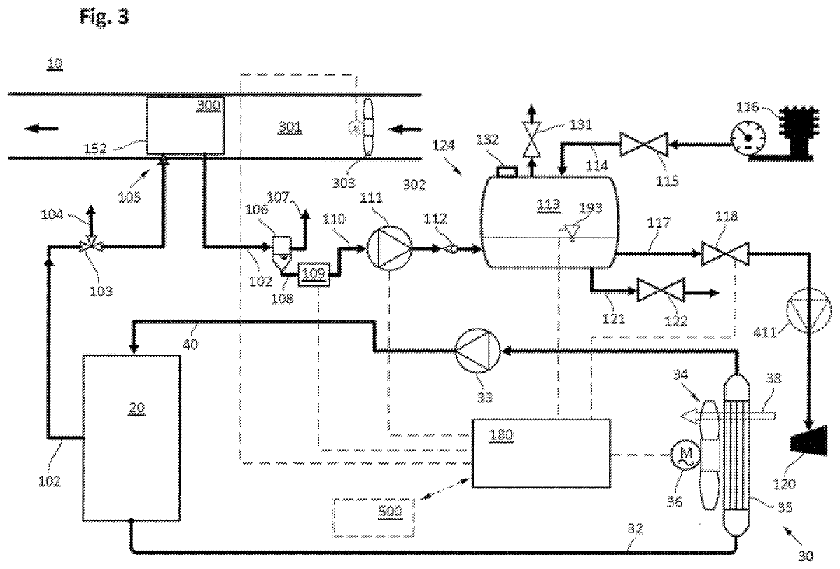

FIG. 3 schematically shows an embodiment example in which the exhaust gas cooler 105 comprises a heat exchanger 300 arranged to transfer heat from the exhaust gas of the fuel cell 20 flowing through the exhaust line 102 via a wall 152 to a flow of ambient air, which is used here as a cooling medium for the heat exchanger 300. For example, the heat exchanger 300 may be disposed in or on an air duct 301. A forced air flow may be generated in the air duct 301, for example, by a fan 303. The heat exchanger 300 may also be cooled, for example, by an airstream, and the heat exchanger 300 may be arranged freely on the vehicle, for example, that is, without an air duct 301, such as on the underbody of the vehicle. In the case of an air duct 301 or fan 303, control of the exhaust gas cooler 105 by the control means 180 may be accomplished, for example, by controlling the fan 303 and/or by controlling air dampers. The fuel cell system may otherwise be structured like the fuel cell system 10 of FIG. 1.

In the embodiment examples described, a control of the exhaust gas cooler 105 may also be performed by controlling the branch valve 103, for example by supplying the exhaust gas flow to the exhaust gas cooler 105 completely, partially and/or not at all. Control of the water collection device 100 may be accomplished, for example, by controlling the operation of the exhaust gas cooler 105 and/or, for example, by controlling the operation of the high pressure pump 111. Excess exhaust gas or excess water in the exhaust gas may be discharged, for example, through the outlet line 107 from the gas-liquid separator 106.

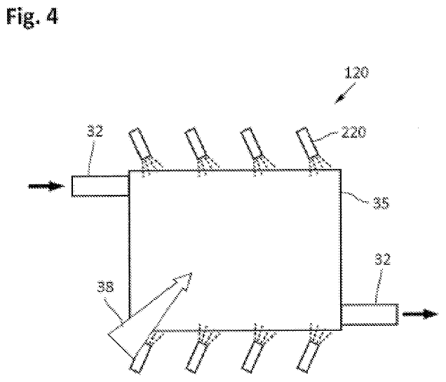

FIG. 4 schematically illustrates the water ejection device 120 according to embodiments of the invention. The water ejection device 120 is designed, for example, as a water spraying device and comprises one or more nozzles 220 for spraying the water onto the cooler 35, for example onto cooling fins or a surface of the cooler 35, and into the supply air stream of the cooler 35. The supply air stream is the inlet-side part of the cooling air stream 38. As shown schematically in FIG. 4, the cooling medium flows through the cooler 35 as part of the cooling circuit 32. The cooling medium thereby transfers heat to the cooling air stream 38 by heat exchanger. The sprayed-on or sprayed-in water can cause the following physical mechanisms to increase the cooling capacity of the cooler 35: an evaporation (non-adiabatic) of water on the cooler surface, concurrent with a transfer of heat from the cooler 35 to the water; an evaporation (adiabatic) in the air stream 38, decreasing the air inlet temperature of the cooling air stream 38 at the cooler 35; and an increase in the heat capacity of the water-enriched cooling air stream 38 entering the cooler.

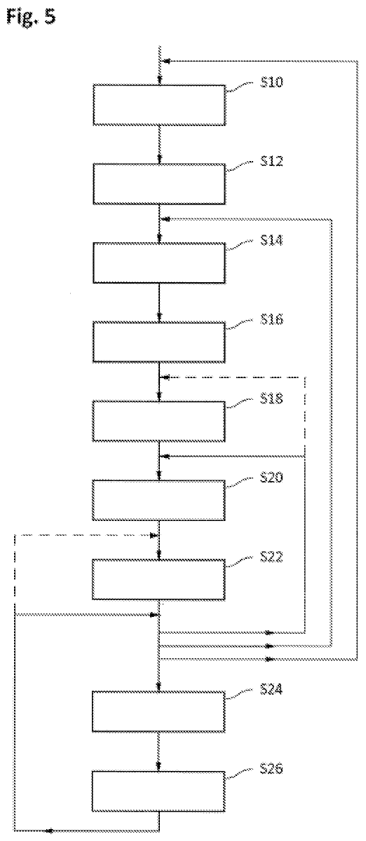

FIG. 5 schematically illustrates an operating method of the fuel cell system according to embodiments of the invention, controlled by the control means 180.

Based on a predetermined route or a route usually traveled by the vehicle, a current route is determined that has a high probability of being traveled. Based on this route plan (S10) and based on vehicle data such as a vehicle mass and a current and/or expected ambient temperature, a route plan is determined (S12). The route plan comprises route data as a function of a location s and a time t of the vehicle, for example, the expected slope of the roadway at location s and time t and/or an expected driving speed at location s and time t. The route data can also be adjusted using, for example, weather data or weather data, such as ambient temperature, and data about the traffic situation on the planned route. This data can be obtained, for example, from cloud-based services or an infotainment system of the vehicle. Steps S10 and S12 can be combined by determining the route plan during route planning.

Based on the determined route plan, and for example additionally based on an expected ambient temperature T_{amb}(t) as a function of time t, or an expected ambient temperature T_{amb}(s, t) as a function of time t and location s, and based on the vehicle data, a predictive determination (S14) of a power schedule is performed. The power schedule can be specified, for example, as the expected target power of the fuel cell as a function of the vehicle location s and time t as P_{BZ,soll}(s,t), for example as a sequence of planned operating phases at specific times t and associated locations s with different high power requirements P_{BZ,soll} on the fuel cell.

Based on the power schedule, a cooling power schedule (S16) is determined that correspondingly comprises a sequence of planned operating phases of different high cooling target powers of the cooling device 30 for the fuel cell 20. The target cooling power can be specified as P_{kühl,soll}(s,t). From the cooling power schedule, depending on the expected ambient temperature, an amount of water required by the water ejection device 120 up to a location s and time t is determined, for example as an integral over the required water mass flow \dot{m}, which can be described as ∫\dot{m}(s,t)_{Aufdüsen,soll} (S18). From this, or in a corresponding manner, an amount of water to be collected or generated by the water collection device 100 is determined as a function of location s and time t as ∫\dot{m}(s,t)_{Generierung,soll} (S20). For example, the evaporative cooling device 124 may be configured to generate a water ejection of the water ejection device 120 of, for example, 50 ml/s for maximum cooling performance by evaporative cooling. The water tank 113 may include a water capacity of 200 liters, for example.

While the vehicle is moving, a check may additionally be made to determine whether the cooling circuit 32 or cooling or refrigeration circuit 201 used by the exhaust gas cooler 105 in the heat exchanger for cooling has current remaining capacity for cooling (S22), and based on the result, an adjustment may be made to the determined amounts of water required for ejecting and/or generating.

Depending on the determined value of the current amount of water to be generated, and possibly adjusted based on the determined residual capacity of the respective cooling circuit, a selective choice (S24) of an operating mode for the fuel cell system 10 is performed by the control means 180. In particular, the following operating modes can be chosen in accordance with the required water quantity, and thus in accordance with the model-predictively determined power requirements for the fuel cell in accordance with the power schedule: a first operating mode corresponding to a deactivated water collection device 100; a second operating mode corresponding to an active operation of the water collection device 100 for collecting liquid water from the exhaust gas of the fuel cell and supplying the collected water to the water tank 113; and a third operating mode for water ejection in which water is ejected by the water ejection device 120, thereby increasing the cooling capacity of the cooler 35 for the cooling device for cooling the fuel cell 20.

The control means 180 controls the fuel cell system 10 according to the selected operating mode (S26). In particular, the control means 180 may control the water collection device 100 according to the formed operating mode, in particular the exhaust gas cooler 105 and/or the high pressure pump 111, and the control means 180 may control the water ejection device 120 for example by controlling the valve 118. For checking the current operating phase and selecting the next operating phase, a return is made to step S22 or before step S24.

While the vehicle is moving, an adjustment of the predictive determination of the power schedule can be made based on a current driving situation, current vehicle data, and in particular a current ambient temperature (S14). In this case, the steps following step S14 can also be adjusted.

In addition, an adjustment of the route planning (S10) can take place during the journey due to current route influences, such as traffic conditions (congestion, etc.), current weather conditions and current ambient temperature, whereby the steps following step S10 are also adjusted.

In embodiments, the fuel cell system may comprise an external data unit 500, and the control means may be arranged to communicate with the external data unit 500, for example via mobile communications. The external data unit 500 may, for example, perform steps S10 (route planning) and/or S12 (route planning). Vehicle data may be communicated from the control means 180 to the external data unit 500. For example, the power schedule, the cooling power schedule, and the data on the amount of water required and the amount of water to be collected may be communicated from the external data unit 500 to the control means 180 when determined by the external data unit 500. Preferably, the residual capacity check is performed by the control means 180, i.e., on the vehicle side. Of the described method steps, some may be performed by the external data unit 500 in advance of the trip or during the trip away from the vehicle, for example by a cloud-based system or other server. Both the power schedule described at step S14 and the cooling power schedule described at step S16 may be used by the control means 180 as the power schedule for selecting the corresponding operating modes.

As an alternative to the pressurized water tank 113 of the embodiments described, which is filled by the high pressure pump 111, a non-pressurized water tank 113 may be provided, and instead of or in addition to the high pressure pump 111, a pump 411 may be provided to supply water from the water tank 113 to the water ejection device 120. The water ejection device 120 may be controlled by actuating the optional valve 118 and/or said pump 411.

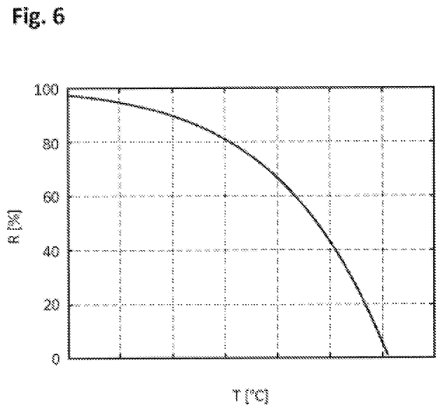

FIG. 6 schematically shows an example of the relative condensation rate R of the gaseous product water in the exhaust gas of the fuel cell 20 as a function of the exhaust gas temperature or the temperature T of the exhaust gas reached in the exhaust gas cooler 105. The figure shows an approximately exponential course of the function. From the curve of the condensation rate R, it can be seen that a large amount of liquid water can be generated from the exhaust gas even when the exhaust gas is cooled by a relatively small temperature difference. Together with the water tank 113, a supply of water can thus be efficiently created for cooling the cooler 35 in later operating phases of the fuel cell 20 with higher fuel cell power.

### REFERENCE NUMERALS

10 fuel cell system
20 fuel cell
30 cooling device
32 cooling circuit
33 pump
34 fan
35 cooler
36 fan drive
38 cooling air flow
40 primary path
100 water collection device
101 secondary path
102 exhaust line
103 branch valve
104 exhaust line
105 exhaust gas cooler
106 liquid separator
107 outlet line
108 pipeline
109 water reservoir
110 pipeline
111 high pressure pump
112 check valve
113 water tank
114 pipeline
115 valve
116 pressure source
117 water line
118 valve
120 water ejection device
121 drain opening
122 drain valve
124 evaporative cooling system
130 valve
131 pressure release valve
132 closure
150 heat exchanger
152 wall
180 control means
193 sensors
200 secondary path
201 refrigeration circuit
220 nozzles
300 heat exchanger
301 air duct
303 fan
411 pump
500 data unit

What is claimed is:

1. A fuel cell system for a vehicle, including:
a fuel cell;
an exhaust line for exhausting exhaust gas containing water from the fuel cell; and
a water collection device for collecting liquid water from the exhaust gas, the water collection device including an exhaust gas cooler, wherein the exhaust gas cooler comprises a heat exchanger disposed on the exhaust line and adapted to, by transferring heat from the exhaust gas to a flow of a cooling medium, cool the exhaust gas passed in the exhaust line via the heat exchanger and condense water contained in the exhaust gas, wherein the water supplied to the heat exchanger with the exhaust gas, including the water condensed therefrom, is discharged from the heat exchanger via the exhaust line;
a water tank coupled to the water collection device downstream of the heat exchanger and adapted to store collected water;
a cooling device for cooling the fuel cell, comprising a cooler;
a water ejection device for ejecting and distributing water on the cooler or in a supply air stream of the cooler; and
a water line for supplying water from the water tank to the water ejection device.

2. The fuel cell system of claim 1, wherein the cooling device for cooling the fuel cell comprises a cooling circuit comprising a cooling medium, the cooling circuit comprising a cooling path that passes over the heat exchanger and that is adapted to provide the flow of the cooling medium over the heat exchanger.

3. The fuel cell system of claim 1, wherein the flow of the cooling medium via the heat exchanger is a flow of air from environment of the vehicle.

4. The fuel cell system of claim 1, wherein the water tank is pressurizable by a pressure source, wherein the water line includes a valve via which the water tank is connectable to the water ejection device, wherein the water ejection device is arranged to eject water from the water tank connected by the valve by the pressure applied to the water tank and to distribute it on the cooler or in a supply air flow of the cooler.

5. The fuel cell system of claim 1, further comprising a pump adapted to feed water discharged from the heat exchanger via the exhaust line into the water tank against pressure applied to the water tank.

6. The fuel cell system of claim 1, further comprising a control means which is arranged for an operating method of the fuel cell system in which:
by the control means, based on a power schedule comprising a sequence of planned operating phases with different power requirements for the fuel cell, operating modes for the fuel cell system are selectively chosen according to the planned operating phases, which operating modes comprise at least one operating mode for water collection and at least one operating mode for water ejection,
wherein in the at least one operating mode for water collection, the water collection device is operated to collect liquid water from the exhaust gas and supply it to the water tank, and
wherein, in the at least one operating mode for water ejection, water is supplied from the water tank to the water ejection device and ejected from the water ejection device and distributed on the cooler or in a supply air stream of the cooler.

7. The fuel cell system of claim 6, wherein the power schedule determines a power requirement for the fuel cell as a function of a location history of the vehicle and/or a time history.

8. The fuel cell system of claim 6, wherein the at least one operating mode for water ejection comprises an operating mode for water ejection in which the water collection device is not actively operated.

9. The fuel cell system of claim 6, wherein the control means is adapted to adjust the power schedule during travel of the vehicle based on a current movement of the vehicle.

10. The fuel cell system of claim 1, wherein the cooler includes a fan drive, the fuel cell system comprising one or more control means adapted for a water ejection operation mode, wherein the water ejection device ejects and distributes water on the cooler or in a supply air stream of the cooler, and wherein the control means controls a power of the fan drive of the cooler.
